(19) United States
(12) Patent Application Publication
(10) Pub. No.: US 2020/0347987 A1
(43) Pub. Date: Nov. 5, 2020

(54) SUPPORTING STAND AND METHOD OF MANUFACTURING FRAME OF SUPPORTING STAND

(71) Applicant: SYNCMOLD ENTERPRISE CORP., New Taipei City (TW)

(72) Inventors: Yuan-Chi LEE, New Taipei City (TW); Chih-Hsin CHOU, New Taipei City (TW); Tung-Chiung CHEN, New Taipei City (TW); Ching-Hui YEN, New Taipei City (TW)

(21) Appl. No.: 16/864,318

(22) Filed: May 1, 2020

Related U.S. Application Data
(60) Provisional application No. 62/842,054, filed on May 2, 2019.
(60) Provisional application No. 62/887,326, filed on Aug. 15, 2019.

(30) Foreign Application Priority Data
Mar. 9, 2020 (TW) 109107723

(51) Int. Cl. F16M 11/10; F16M 11/04; B29C 48/00; B29C 48/16

(52) U.S. Cl. CPC F16M 11/10; F16M 11/046; B29L 2031/7502; B29C 48/002; B29C 48/16; B29C 48/0022

(57) ABSTRACT

A supporting stand is disclosed, wherein the supporting stand is utilized for supporting a display on a working surface that comprises a base, a frame, and a bearing module. The invention also relates to a method of manufacturing frame of supporting stand, which includes an extrusion step, a cutting step, a processing step, and a removal step.

### CROSS REFERENCE TO RELATED APPLICATION

This application claims the benefit of U.S. Provisional Application Ser. No. 62/842,054 filed on May 2, 2019, the benefit of U.S. Provisional Application Ser. No. 62/887,326 filed on Aug. 15, 2019, and the benefit of Taiwan Patent Application Serial No. 109107723 filed on Mar. 9, 2020. The entirety of each Application is incorporated herein by reference.

### BACKGROUND OF THE INVENTION

### 1. Field of the Invention

The present invention relates to a supporting stand. More particularly, the present invention relates to a supporting stand for supporting a display. The present invention also relates to a method of manufacturing a frame of the supporting stand.

### 2. Description of Related Art

Demands for a frame of a supporting stand for a display that has a thin and light appearance with asymmetrical shapes are continuously growing. In a case, if the die-casting method is used to manufacture a frame of which a top plate is inclined at an angle of 45 with a bottom plate, the de-molding convenience should be considered, and a draft angle will be necessary and be designed in advance. However, the design for the draft angle will increase the thickness of the frame. Thus, after de-molding, an extra cutting process is needed to cut off the thickened part of the frame. Also, if multiple plates such as mainboards, side plates, top plates, and bottom plates are manufactured by methods as stamping or the like, forming locking holes on each of the plates is necessary and these locking holes are formed correspondingly to their counterparts. These said plates are then assembled one by one by fasteners.

The present invention provides a method for manufacturing a frame of a supporting stand, which includes a first step of forming a metal extrusion by a metal extrusion process, and followed by cutting and processing respectively to obtain the frame of the supporting stand.

### SUMMARY OF THE INVENTION

The main object of the present invention is to provide a supporting stand for supporting a display on a working surface. The supporting stand comprises a base being placed on the working surface, a frame being disposed on the base and including two side plates, a top plate, at least one supporting plate, and an accommodating space that is surrounded and defined by the side plates, the top plate, and the at least one supporting plate, and a bearing module being disposed in the accommodating space and bearing for display.

Furthermore, the side plates, the top plate, and the at least one supporting plate is a one-piece metal extrusion. Each of the side plates includes a first edge, a second edge corresponding to the first edge, a top edge, and a bottom edge, in which the first edges and the second edges extend along a first direction and a length of the first edges is smaller than a length of the second edges, while the top edge extends along a second direction and connected to the top plate. The at least one supporting plate is connected to the side plates and adjacent to the first edges, and the frame is connected to the base through the bottom edges of the side plates.

In one embodiment, the first direction and the second direction are non-parallel to each other and include an angle smaller than 90°.

In one embodiment, a first projection of the top plate is projected along the second direction on a plane parallel to the third direction, while a second projection of the top plate is projected along the second direction on a plane parallel to the first direction, wherein an area of the first projection is smaller than an area of the second projection.

In one embodiment, the at least one supporting plate has a top surface and a bottom surface respectively parallel to the second direction. Furthermore, a third projection of the at least one supporting plate is projected along the second direction on a plane parallel to the third direction, while a fourth projection of the at least one supporting plate is projected along the second direction on a plane parallel to the first direction, wherein an area of the third projection is smaller than an area of the fourth projection.

In one embodiment, the at least one supporting plate has a first surface facing the accommodating space, a second surface opposite to the first surface, and at least one locking hole, wherein the locking hole is formed on the first surface or penetrated through the first surface and the second surface, the bearing module is thus able to be connected to the supporting plate through a plurality of screws which pass through the bearing module and are screwed to the at least one locking hole.

In one embodiment, the base includes at least one first engagement structure, while each of the side plates includes at least one second engagement structure formed on the bottom edge, wherein the at least one first engagement structure is engaged to the second engagement structure.

In one embodiment, the frame is made of aluminum or aluminum alloy.

In one embodiment, the display is adjacent to the second edges of the frame, the supporting stand further comprises a back plate, the back plate is fixed to the at least one supporting plate, wherein the back plate is disposed on the frame away from the display and adjacent to the first edges of the side plates.

The present invention further disclosed a method of manufacturing a frame of a supporting stand for supporting a display, which comprises the steps of:

an extrusion step: providing a mold with an opening, forming an extrusion block along a second direction by metal extrusion, the extrusion block includes two side primary boards, a top primary board, a bottom primary board, and N spacer primary boards, wherein N is a positive integer;

a cutting step: cutting the extrusion block along a first direction to obtain a plurality of elongated bodies, wherein each of the elongated bodies includes two side board, a top board, a bottom board, N spacer boards, and N+1 interval spaces, wherein the interval spaces are spaced by the spacer boards and defined by the side boards and the spacer boards;

a processing step: removing the bottom board and a portion of the side boards; and

a removal step: removing a portion of the spacer boards to obtain the frame, wherein the frame has two side plates, a top plate, N supporting plates, and an accommodating space.

Each of the side plates has a first edge, a second edge corresponding to the first edge, a top edge, and a bottom edge, wherein the first edges and the second edges extend along the first direction, while the top edge extends along the second direction. Furthermore, the top plate extends along the second direction as well.

In one embodiment, in the extrusion step, a cross-sectional shape of the opening of the mold in a third direction perpendicular to the second direction is the same as a cross-sectional shape of the extrusion block in the third direction.

In one embodiment, in the processing step, the elongated bodies are cut in a fourth direction perpendicular to the first direction to remove the bottom board and the portion of the side boards.

In one embodiment, in the removal step, the portion of the spacer boards is removed through a milling process, so that the N+1 interval spaces are interconnected into the accommodating space.

In one embodiment, in the removal step, the supporting plate has a top surface and a bottom surface parallel to the second direction.

In one embodiment, in the removal step, a thickness direction of the spacer boards is different to a thickness direction of the supporting plates.

In one embodiment, the method further comprises a drilling step: forming at least one locking hole on a first surface of the supporting plates, wherein the first surface faces the accommodating space.

In one embodiment, the method further comprises a reprocessing step: forming at least one second engagement structure on each of the bottom edges.

In one embodiment, the first edges are shorter than the second edges, and the first direction and the second direction are non-parallel and include an angle smaller than 90°.

In one embodiment, a first projection of the top plate is projected along the second direction on a plane parallel to the third direction, while a second projection of the top plate is projected along the second direction on a plane parallel to the first direction, wherein an area of the first projection is smaller than an area of the second projection.

In one embodiment, a third projection of the supporting plate is projected along the second direction on a plane parallel to the third direction, while a fourth projection of the supporting plate is projected along the second direction on a plane parallel to the first direction, wherein an area of the third projection is smaller than an area of the fourth projection.

In one embodiment, the supporting plates are connected to the side plates and adjacent to the first edges thereof.

### BRIEF DESCRIPTION OF THE DRAWINGS

FIG. 1 is a front view showing an embodiment of a supporting stand of the present invention;

FIG. 2 is a back view showing an embodiment of a supporting stand of the present invention;

FIG. 3 is an exploded perspective view showing an embodiment of a supporting stand of the present invention;

FIG. 4 is a schematic perspective view showing an embodiment of a frame of the present invention;

FIG. 5 is a schematic perspective view showing an embodiment of an extrusion block of the present invention;

FIG. 6 is a front view showing an embodiment of an extrusion block of the present invention;

FIG. 7 is a schematic diagram showing an embodiment of a cutting step for an extrusion block of the present invention;

FIG. 8 is a schematic perspective view showing an embodiment of an elongated body of the present invention;

FIG. 9 is a perspective rear view showing an embodiment of a frame of the present invention; and

FIG. 10 is a preparation flowchart of an embodiment of a frame of the present invention.

### DETAILED DESCRIPTION OF THE PREFERRED EMBODIMENT

Hereinafter, the supporting stand and the method of manufacturing the frame of the supporting stand of the present invention will be described.

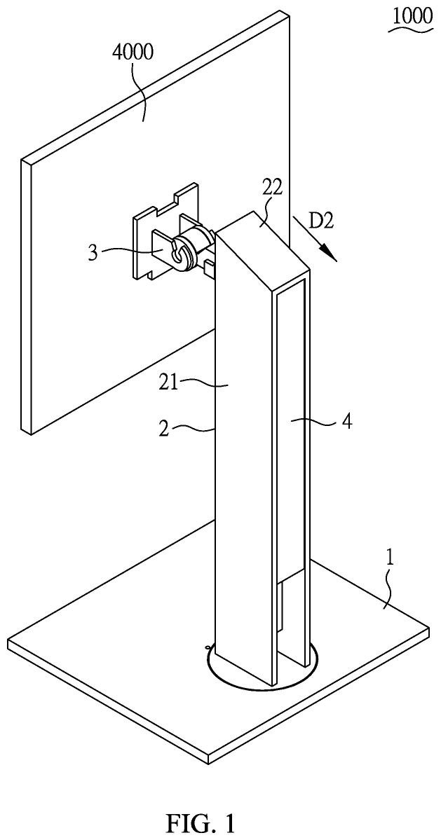

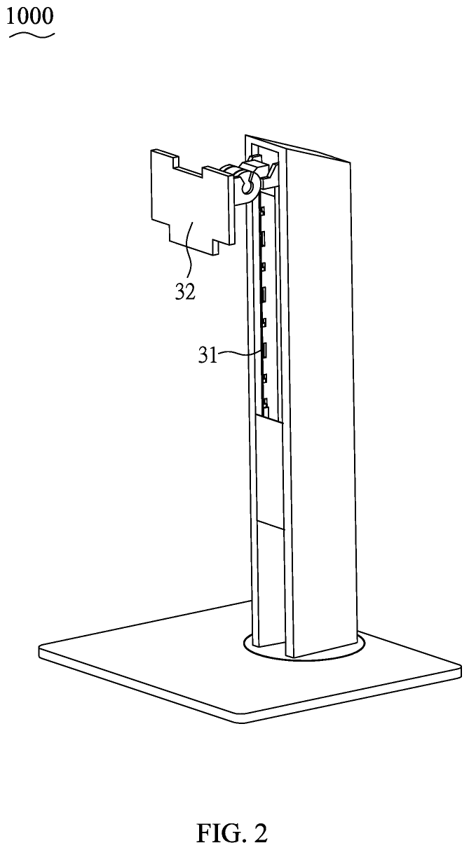

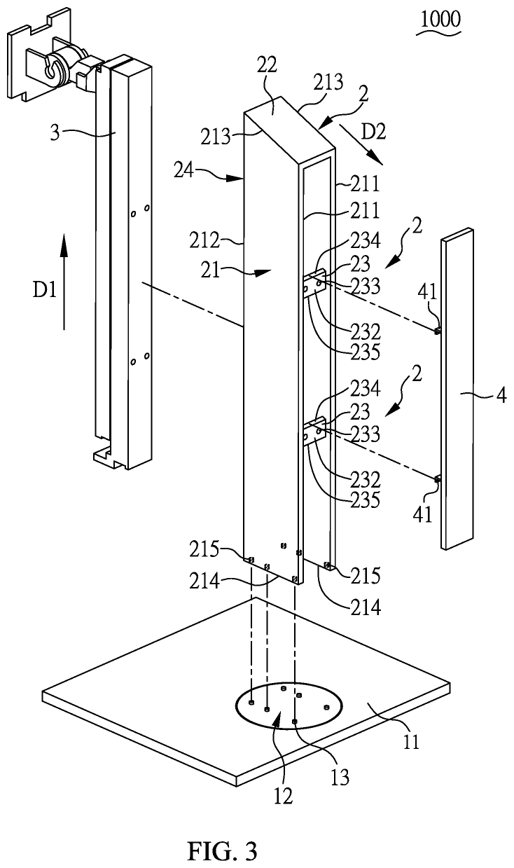

Please refer to FIG. 1 to FIG. 3, in which FIG. 1 and FIG. 2 respectively represent a front view and a back view showing a supporting stand 1000 of an embodiment of the present invention, while FIG. 3 is an exploded perspective view of the supporting stand 1000. The supporting stand 1000 is used for supporting a display 4000 on a working surface, and comprises a base 1, a frame 2, a bearing module 3, and a back plate 4.

The base 1, allowing the frame 2 to be disposed thereon, is placed on the working surface. The base 1 includes a mainboard 11, a rotating plate 12, and six first engaging structures 13. The rotating plate 12 is disposed on the mainboard 11 and can be rotating relative to the mainboard 11. The frame 2 may be connected to the rotating plate 12 by being engaged to the first engaging structures 13 formed on the rotating plate 12, thus the frame 2 can be rotating relative to the mainboard 11. Therefore, a viewing angle of the display 4000 can also be adjusted by rotating the frame 2 when using.

The frame 2 comprises two side plates 21, a top plate 22, two supporting plates 23, and an accommodating space 24, wherein the side plates 21, the top plate 22, and the supporting plates 23 are a one-piece metal extrusion manufactured by metal extrusion followed by a cutting step. Namely, the side plates 21, the top plate 22, and the supporting plates 23 are integrally formed.

In FIG. 3, each of the side plates 21 includes a first edge 211, a second edge 212 corresponding to the first edge 211, a top edge 213, a bottom edge 214, and at least one second engaging structure 215. In each of the side plates 21, the first edge 211 and the second edge 212 extend along a first direction D1; the top edge 213, which is connected to the first edge 211 and the second edge 212 by two ends, extends along a second direction D2 and is connected to the top plate 22; the bottom edge 214, which is also connected to the first edge 211 and the second edge 212 by two ends, is disposed corresponding to the top edge 213 and connected to the base 1. In the present embodiment, a length of the first edge 211 is smaller than a length of the second edge 212; moreover, the first direction D1 and the second direction D2 are non-parallel and include an angle smaller than 90°. Besides, the at least one second engaging structures 215 are formed on the bottom edges 214 and corresponding to the first engaging structures 13 on the base 1; hence, these second engaging structures 215 and these first engaging structures 13 may be engaged with each other respectively. Through the engagement, the frame 2 can be stably disposed on the base 1.

The top plate 22 is connected to the side plates 21, extends along the second direction D2, and is inclined relative to the base 1. In other words, the top plate 22 is not parallel or vertical to the base 1.

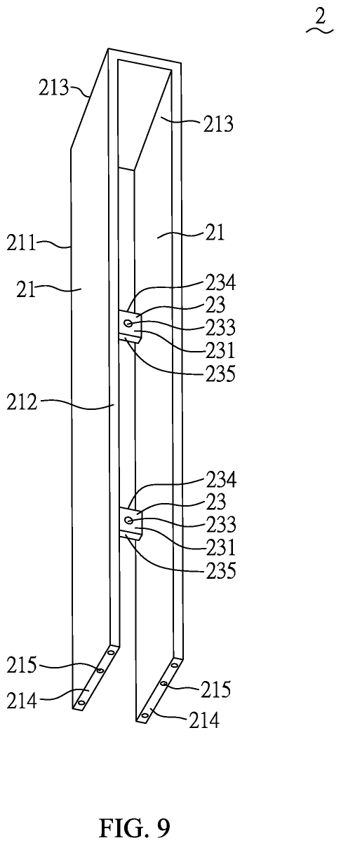

Each of the supporting plates 23 is connected between the side plates 21, adjacent to the first edges 211 and away from the second edges 212. As shown in FIG. 9, each of the supporting plates 23 has a first surface 231, a second surface 232 opposite to the first surface 231, two locking holes 233, a top surface 234, and a bottom surface 235. The numbers and the locations of the locking holes 233 is not limited thereto, which means that each of the locking holes 233 can be selectively formed only on the first surface 231 as a blind hole or formed as a through-hole penetrated through the first surface 231 and the second surface 232, thus the bearing module 3 is facilitated locked on the supporting plates 23.

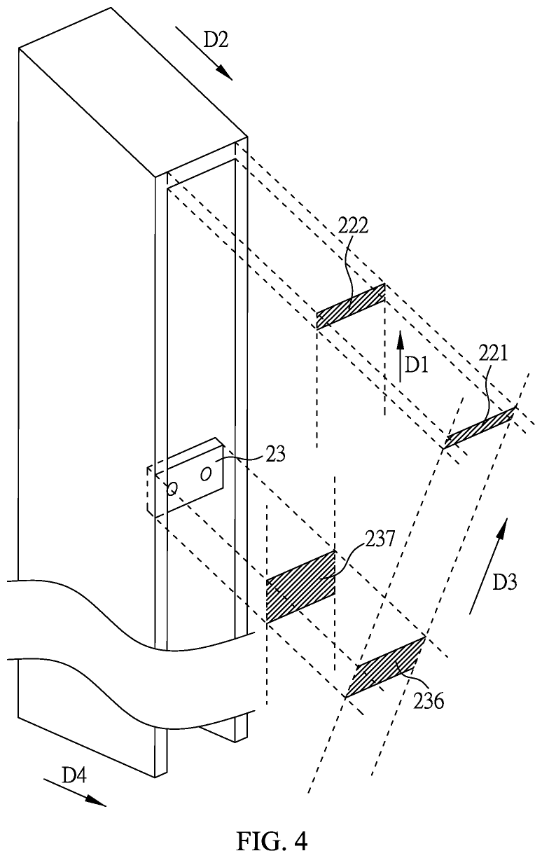

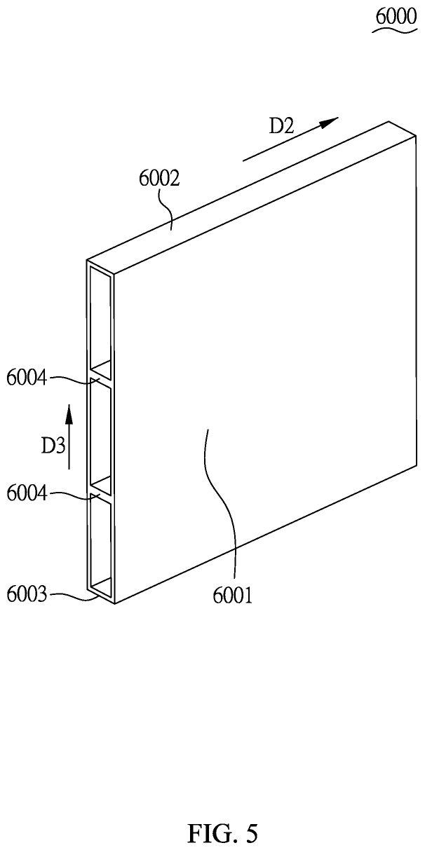

The side plates 21, the top plate 22, and the supporting plate 23 are manufactured by metal extrusion and thus forming a one-piece metal extrusion. In the embodiment, the extrusion step is an aluminum extrusion process, by which process the top surface 234 and the bottom surface 235 of each of the supporting plates 23 are parallel to the top plate 22, that is, parallel to the second direction D2. As shown in FIG. 5, the metal extrusion is extruded along the second direction D2 to form an extrusion block 6000 first and then followed by a process to obtain the frame 2; moreover, an acute angle is formed between the first direction D1 and the second direction D2. Therefore, as shown in FIG. 4, a first projection 221 of the top plate 22 is projected along the second direction D2 on a plane parallel to the third direction D3, which is perpendicular to the second direction D2, while a second projection 222 of the top plate 22 is projected along the second direction D2 on a plane parallel to the first direction D1, an area of the first projection 221 is smaller than an area of the second projection 222. Also, a third projection 236 of each of the supporting plates 23 is projected along the second direction D2 on a plane parallel to the third direction D3, while a fourth projection 237 of each of the supporting plates 23 is projected along the second direction D2 on a plane parallel to the first direction D1, an area of the third projection 236 is smaller than an area of the fourth projection 237.

The accommodating space 24 is surrounded and defined by the side plates 21, the top plate 22, and the supporting plates 23. The bearing module 3 is disposed in the accommodating space 24 through a plurality of screws, wherein these screws pass through the bearing module 3 and are screwed to the locking holes 233 of the supporting plates 23 to connect the supporting plates 23 and the bearing module 3. The bearing module 3 may be any kind of bearing module for carrying a display 4000 in the art, however, in the present embodiment, the bearing module 3 includes a pair of slide rails 31 and a slider 32. Each of the slide rails 31 is respectively fixed to different inner surfaces of the frame 2, and thus the slider 32 may be slidably clamped between the slide rails 31. Namely, the slider 32 can move up and down relative to the frame 2. The back plate 4, which is disposed adjacent to the first edges 211 of the side plates 21 and has a plurality of hooks 41, covers the second surface 231, and the hooks 41 are engaged with these supporting plates 23.

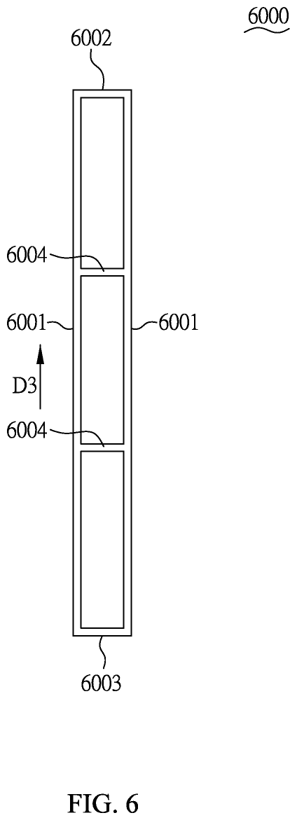

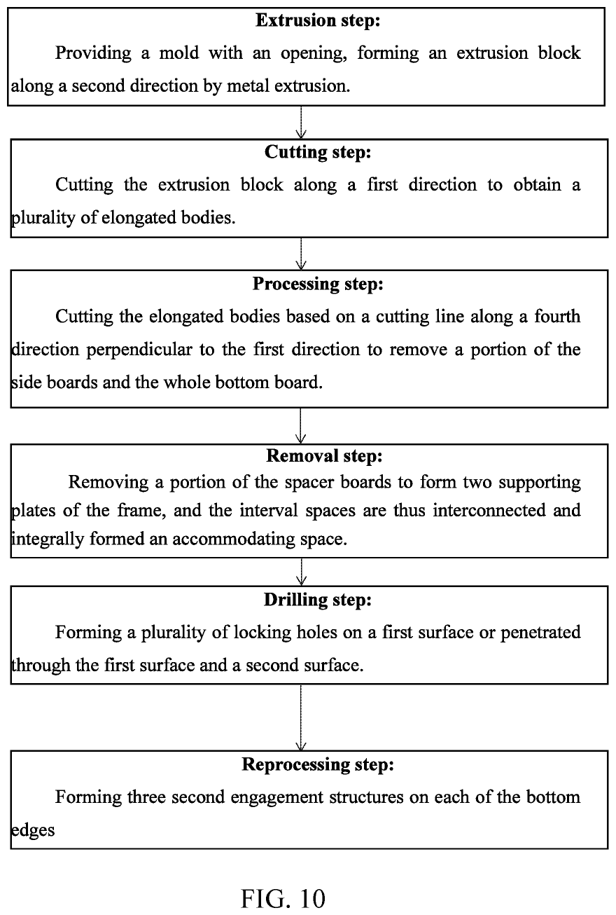

The method of manufacturing the frame 2 mentioned above will be described as followed. Refer to the preparation flowchart shown in FIG. 10, first, an extrusion step is performed by providing a mold with an opening, forming an extrusion block 6000 along a second direction D2 by metal extrusion, in which the schematic perspective view of the extrusion block 6000 is shown as FIG. 5, and the extrusion block 6000 has a cross-sectional shape in a third direction D3 perpendicular to the second direction D2, while a shape of the opening of the mold used for metal extrusion is identical to the cross-sectional shape of the extrusion block 6000, as shown in FIG. 6.

The extrusion block 6000 includes two side primary boards 6001, a top primary board 6002, a bottom primary board 6003, and two spacer primary boards 6004. However, in other embodiments, the number of the spacer primary boards 6004 is not particularly limited and can be adjusted depending on the needs of locking and the required supporting strength. In general, the number of the spacer primary boards 6004 is a positive integer N.

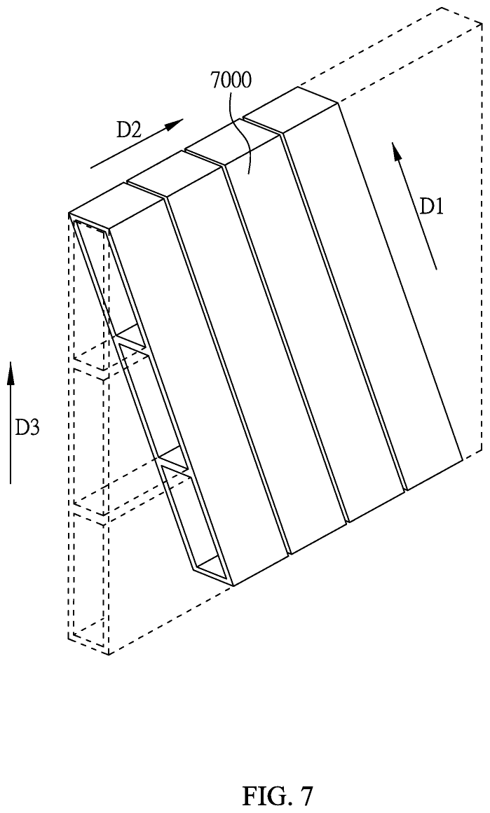

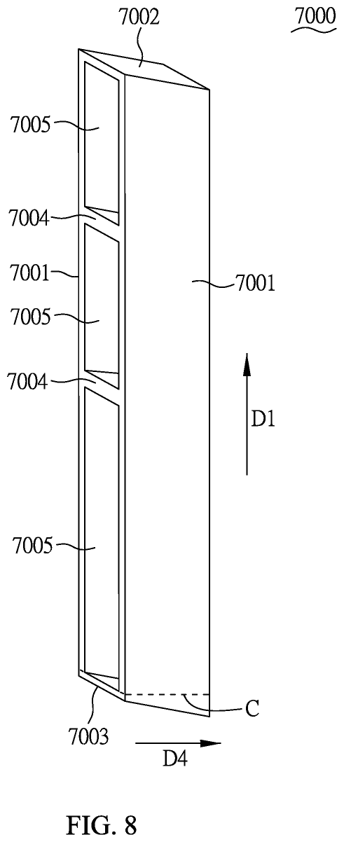

Then, a cutting step is performed. As shown in FIG. 7, the extrusion block 6000 is cut along a first direction D1 to obtain a plurality of elongated bodies 7000, wherein the first direction D1 and the second direction D2 are non-parallel and have an angle smaller than 90° therebetween. After that, as shown in FIG. 8, each of the elongated bodies 7000 includes two side boards 7001, a top board 7002, a bottom board 7003, two spacer boards 7004, and three interval spaces 7005, wherein the interval spaces 7005 are spaced by these spacer boards 7004 and defined by the side boards 7001 and the spacer boards 7004. Next, as shown in FIG. 8, a processing step is performed for each of the elongated bodies 7000, wherein each of the elongated bodies 7000 is cut based on a cutting line C (dashed line) along a fourth direction D4 perpendicular to the first direction D1 to remove a portion of the side boards 7001 and the whole bottom board 7003. After the processing step, the side boards 7001 are cut to form the two bottom edges 214 of the frame 2 respectively. Next, a removal step is performed. By method as the milling process, a portion of the spacer boards 7004 can be removed to form the two supporting plates 23 of the frame 2, and the interval spaces 7005 are thus interconnected and integrally formed an accommodating space 24 after removing a part of the spacer boards 7004. Moreover, a thickness direction of the spacer boards 7004 is different from a thickness direction of the supporting plates 23. After that, a drilling step is performed. In this step, a plurality of locking holes 233 are formed on a first surface 231 or penetrated through the first surface 231 and a second surface 232 of the supporting plates 23. Next, a reprocessing step is performed to form three second engagement structures 215 on each of the bottom edges 214, and thus obtained the frame 2 of the present embodiment shown in FIG. 9.

In other embodiments, the number of the spacer boards 7004 is not particularly limited and may depend on the requirements of the locking and the required supporting strength. Generally, the number of the spacer boards 7004 is a positive integer N, and the number of the interval spaces 7005 spaced out by the spacer boards 7004 is N+1. In addition, the included angle between the first direction D1 and the second direction D2 will define the inclination of the top plate 22. Thus, the included angle can be determined and adjusted according to the requirements of the appearance design.

In detail, the frame 2 manufactured from the processes mentioned above is obtained by processing the extrusion block 6000 via metal extrusion. Thus, the side plates 21, the top plate 22, and the supporting plates 23 are integrally formed as a one-piece extrusion. Moreover, since the supporting plates 23 are manufactured by removing a part of the spacer boards 7004, the top surface 234 and the bottom surface 235 are inclined along the second direction D2, that is, parallel to the top plate 22. Besides, the extrusion block 6000 is extruded along the second direction D2 and being cut along the first direction D1 to obtain the elongated bodies 7000, and because the angle formed between the first direction D1 and the second direction D2 is an acute angle, a cross-sectional area of the elongated body 7000 viewed in the second direction D2 is smaller than another cross-sectional area of the elongated body 7000 viewed in the fourth direction D4, and the frame 2 that processed from the elongated body 7000 still retains the afore feature. That is, as shown in FIG. 4, when the frame 2 is projected along the second direction D2 on a plane parallel to the third direction D3, areas of the first projection 221 of the top plate 22 and the third projection 236 of the supporting plates 23 are respectively smaller than areas of the second projection 222 of the top plate 22 and the fourth projection 237 of each of the supporting plates 23 obtained by projecting the frame 2 along the second direction D2 on a plane parallel to the first direction D1.

In other embodiments, the top surface 234 or the bottom surface 235 of each of the supporting plates 23 may further be ground to change their inclined angle. For example, the top surface 234 or the bottom surface 235 can be ground to be disposed along the fourth direction D4, that is, a surface parallels to the bottom edge 214.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A supporting stand for supporting a display on a working surface, the supporting stand comprising:
a base being placed on the working surface;
a frame being disposed on the base and including two side plates, a top plate, at least one supporting plate, and an accommodating space being surrounded and being defined by the side plates, the top plate, and the at least one supporting plate, wherein the side plates, the top plate, and the at least one supporting plate is a one-piece metal extrusion, each of the side plates includes a first edge, a second edge corresponding to the first edge, a top edge, and a bottom edge, the first edges and the second edges extend along a first direction, a length of each of the first edges is smaller than a length of each of the second edges, the top edges extend along a second direction and are connected to the top plate, the at least one supporting plate is connected to the side plates and adjacent to the first edges, and the frame is connected to the base through the bottom edges of the side plates; and
a bearing module being disposed in the accommodating space for bearing the display.

2. The supporting stand as claimed in claim 1, wherein the first direction and the second direction are non-parallel to each other and include an angle smaller than 90° therebetween.

3. The supporting stand as claimed in claim 2, wherein a first projection of the top plate is projected along the second direction on a plane parallel to a third direction, a second projection of the top plate is projected along the second direction on a plane parallel to the first direction, wherein the third direction is perpendicular to the second direction and an area of the first projection is smaller than an area of the second projection.

4. The supporting stand as claimed in claim 3, wherein the at least one supporting plate has a top surface and a bottom surface, which are parallel to the second direction, a third projection of the at least one supporting plate is projected along the second direction on a plane parallel to the third direction, a fourth projection of the at least one supporting plate is projected along the second direction on a plane parallel to the first direction, wherein an area of the third projection is smaller than an area of the fourth projection.

5. The supporting stand as claimed in claim 4, wherein the at least one supporting plate has a first surface facing the accommodating space, a second surface opposite to the first surface, and at least one locking hole, wherein the at least one locking hole is formed on the first surface or penetrated through the first surface and the second surface, the bearing module is connected to the supporting plate through a plurality of screws which pass through the bearing module and are screwed to the at least one locking hole.

6. The supporting stand as claimed in claim 5, wherein the base includes at least one first engagement structure, each of the side plates includes at least one second engagement structure formed on the bottom edge, wherein the at least one first engagement structure is engaged to the at least one second engagement structure.

7. The supporting stand as claimed in claim 1, wherein the frame is made of aluminum or aluminum alloy.

8. The supporting stand as claimed in claim 7, wherein the display is adjacent to the second edges of the frame, the supporting stand further comprises a back plate, the back plate is fixed to the at least one supporting plate, wherein the back plate is disposed on the frame away from the display and adjacent to the first edges of the side plates.

9. A method of manufacturing a frame of a supporting stand for supporting a display, comprising the steps of:
an extrusion step: providing a mold with an opening, forming an extrusion block along a second direction by metal extrusion, the extrusion block including two side primary boards, a top primary board, a bottom primary board, and N spacer primary board, wherein N is a positive integer;
a cutting step: cutting the extrusion block along a first direction to obtain a plurality of elongated bodies, wherein each of the elongated bodies includes two side board, a top board, a bottom board, N spacer board, and N+1 interval spaces, wherein the interval spaces are spaced by the spacer boards and defined by the side boards and the spacer boards;
a processing step: removing the bottom board and a portion of the side boards; and
a removal step: removing a portion of the spacer boards to obtain the frame, wherein the frame has two side plates, a top plate, N supporting plate, and an accommodating space;
wherein each of the side plates has a first edge, a second edge corresponding to the first edge, a top edge, and a bottom edge, wherein the first edges and the second edges extend along the first direction, the top edges extend along the second direction, and the top plate extends along the second direction.

10. The method as claimed in claim 9, wherein the extrusion step, a cross-sectional shape of the opening of the mold in a third direction perpendicular to the second direction is the same as a cross-sectional shape of the extrusion block in the third direction.

11. The method as claimed in claim 9, wherein the processing step, the elongated bodies are cut in a fourth direction perpendicular to the first direction to remove the bottom board and the portion of the side boards.

12. The method as claimed in claim 9, wherein the removal step, the portion of the spacer boards is removed through a milling process, so that the N+1 interval spaces are interconnected and integrally formed the accommodating space.

13. The method as claimed in claim 12, wherein the removal step, the supporting plate has a top surface and a bottom surface, which are parallel to the second direction.

14. The method as claimed in claim 13, wherein the removal step, a thickness direction of the spacer boards is different from a thickness direction of the supporting plate.

15. The method as claimed in claim 9, further comprising a drilling step: forming at least one locking hole on a first surface of the supporting plate, wherein the first surface faces the accommodating space.

16. The method as claimed in claim 15, further comprising a reprocessing step: forming at least one second engagement structure on each of the bottom edges.

17. The method as claimed in claim 9, wherein the first edges are shorter than the second edges, the first direction and the second direction are non-parallel and include an angle smaller than 90°.

18. The method as claimed in claim 17, wherein a first projection of the top plate is projected along the second direction on a plane parallel to the third direction, a second projection of the top plate is projected along the second direction on a plane parallel to the first direction, wherein an area of the first projection is smaller than an area of the second projection.

19. The method as claimed in claim 17, wherein a third projection of the supporting plate is projected along the second direction on a plane parallel to the third direction, a fourth projection of the supporting plate is projected along the second direction on a plane parallel to the first direction, wherein an area of the third projection is smaller than an area of the fourth projection.

20. The method as claimed in claim 9, wherein the supporting plate is connected to the side plates and adjacent to the first edges.
